(19) United States
(12) Patent Application Publication
(10) Pub. No.: US 2008/0147426 A1
(43) Pub. Date: Jun. 19, 2008

(54) SYSTEM AND METHOD FOR MANAGING RECEIPTS OF AN E-FILING PATENT APPLICATION

(75) Inventors: CHUNG-I LEE, Tu-Cheng (TW); HAI-HONG LIN, Shenzhen (CN); DE-YI XIE, Shenzhen (CN); ZHENG-CAI ZHU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO.,LTD., Shenzhen City (CN); HON HAI PRECISION INDUSTRY CO.,, Tu-Cheng (TW)

(21) Appl. No.: 11/838,241

(22) Filed: Aug. 14, 2007

(30) Foreign Application Priority Data
Dec. 15, 2006 (CN) 200610157547.8

(51) Int. Cl. G06Q 10/00

(52) U.S. Cl. 705/1

(57) ABSTRACT

A method for managing receipts of an e-filing patent application is disclosed. The method includes: receiving one or more receipts from a patent office website via the Internet when a patent application is filed in the patent office electronically; uploading the one or more receipts to a file server; obtaining information corresponding to keywords of the one or more receipts; and updating information of the patent application in a database server connected to the file server according to the information corresponding to the keywords. A related system is also disclosed.

### BACKGROUND OF THE INVENTION

1. Field of the Invention

The present invention relates to a system and method for managing receipts of an e-filing patent application.

2. Description of related art

Nowadays, numerous governmental patent offices have popularized filing patent applications electronically. Such offices include the United States Patent and Trademark Office (USPTO), the European Patent Office (EPO), the State Intellectual Property Office of the People's Republic of China (SIPO), the Japanese Patent Office (JPO), and so on. By filing patent applications in the patent offices electronically, a great deal of human and material resources can be saved.

The governmental patent offices return one or more receipts, when a patent application is filed electronically. The following steps are generally adopted to manage the receipts manually: view the receipts; read information of the receipts, such as an application number, a filing date, and fees payment; and update information of the patent application correspondingly.

The conventional method is disadvantageous because of the following reasons:
1. inefficiency: the processes of viewing the receipts, reading information of the receipts, and updating information of the patent application are very redundant and exhausting.
2. inaccuracy: human error is unavoidable, so extra resources are needed to double check the updated information of the patent application.

What is needed, therefore, is a system and method which can manage receipts of an e-filing patent application automatically, for reducing inefficiency and inaccuracy.

### SUMMARY OF THE INVENTION

One preferred embodiment provides a system for managing receipts of an e-filing patent application. The system includes a file server, a database server, and at least one client computer. The at least one client computer includes a receiving module, an updating module, a processing module, and an updating module. The receiving module is configured for receiving one or more receipts from one of the patent office websites via the Internet, when a patent application is filed in the patent office electronically. The uploading module is configured for uploading the one or more receipts to the file server. The processing module is configured for obtaining information corresponding to keywords of the one or more receipts. The updating module is configured for updating information of the patent application in the database server according to the information corresponding to the keywords.

Another preferred embodiment provides a method for managing receipts of an e-filing patent application. The method includes: (a) receiving one or more receipts from a patent office website via the Internet when a patent application is filed in the patent office electronically; (b) uploading the one or more receipts to a file server; (c) obtaining information corresponding to keywords of the one or more receipts; and (d) updating information of the patent application in a database server connected to the file server according to the information corresponding to the keywords.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration and an application environment of a system for managing receipts of an e-filing patent application in accordance with a preferred embodiment;

FIG. 2 is a schematic diagram showing main function modules configured in a client computer; and

FIG. 3 is a flow chart of a preferred method for managing receipts of an e-filing patent application by utilizing the system of FIG. 1.

### DETAILED DESCRIPTION OF THE INVENTION

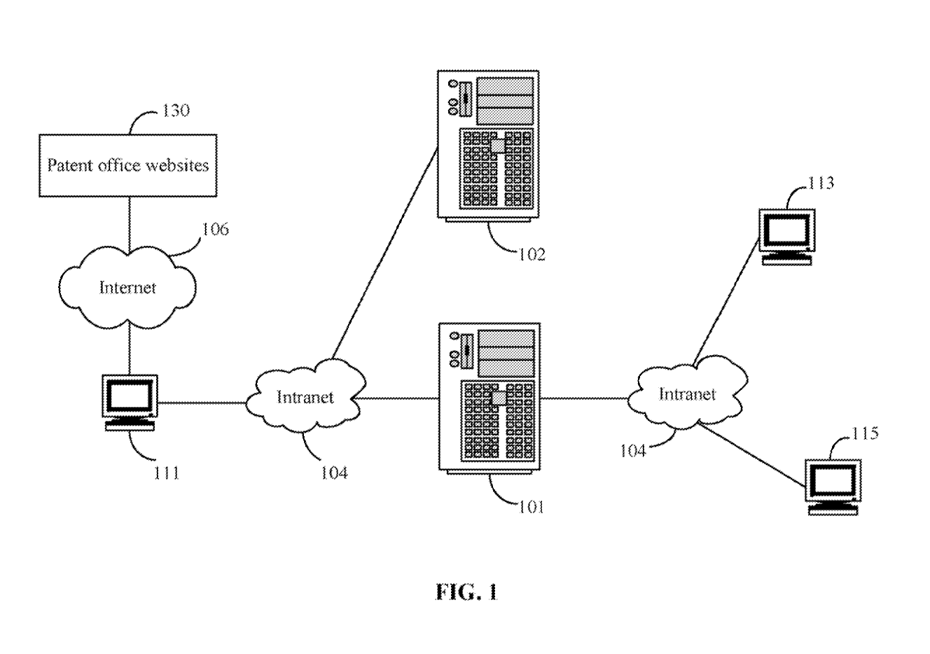

FIG. 1 is a schematic diagram of hardware configuration and an application environment of a system for managing receipts of an e-filing patent application (hereinafter “the system”) in accordance with a preferred embodiment.

The system includes a file server 101, a database server 102, and a plurality of client computers. For the purpose of conveniently illustrating the preferred embodiment of the present invention, three client computers 111, 113, and 115 are shown and described hereinafter. An intranet 104 interconnects all the above-mentioned apparatuses.

The client computers 111, 13, 115, each of which provides an interface of the system, connect with a plurality of patent office websites 130 via the Internet 106 (for simplification, only one connection between the client computer 111 and the patent office websites 130 shown). The patent office websites 130 are websites of governmental patent offices, such as the United States Patent and Trademark Office (USPTO), the European Patent Office (EPO), the State Intellectual Property Office of the People's Republic of China (SIPO), the Japanese Patent Office (JPO), and so on. Each client computer 111, 113, 115 is configured for receiving one or more receipts of an e-filing patent application from one of the patent office websites 130, when the patent application is filed in the patent office electronically.

The file server 101 is configured for storing the one or more receipts of the e-filing patent application.

The database server 102 stores information of the patent application, and is configured for processing the stored information, such as reading, writing, deleting, modifying, updating, and backing up the stored information. The information of the patent application includes an application number, a filing date, a title of the invention, fees payment, an undertaker and so on.

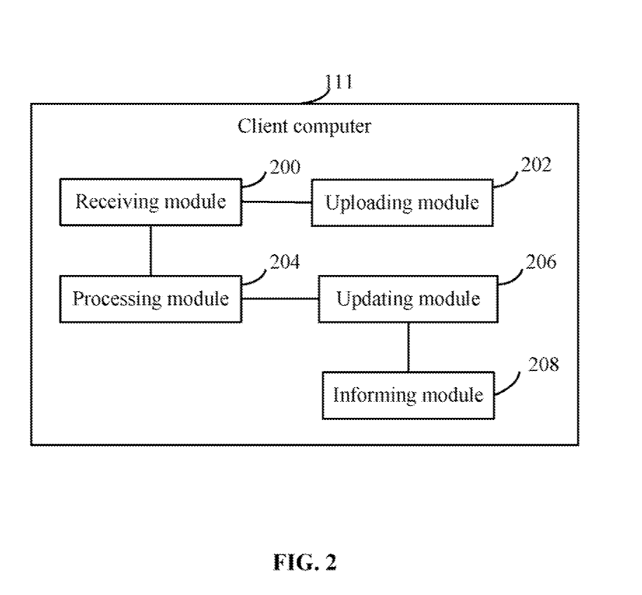

FIG. 2 is a schematic diagram of main function modules configured in the client computer 111. The client computers 113 and 115, each may include function modules similar to that of the client computer 111.

The client computer 111 includes a receiving module 200, an uploading module 202, a processing module 204, an updating module 206, and an informing module 208.

The receiving module 200 is configured for receiving one or more receipts from one of the patent office websites 130 via the Internet 106. The receipts, which can be XML files, PDF files or HTML files, are returned from the patent office website 130, when a patent application is filed in the patent office electronically.

The uploading module 202 is configured for uploading the one or more receipts to the file server 101 via the intranet 104.

The processing module 204 is configured for obtaining information corresponding to keywords of the one or more receipts. In detail, the processing module 204 reads the receipts and obtains information corresponding to keywords of the receipts. The keywords may include one or more of an application number, a filing date, a title of the invention, and fees payment.

The updating module 206 is configured for updating information of the patent application in the database server 102, according to the information corresponding to the keywords. The information of the patent application at least includes an application number, a filing date, a title of the invention, and fees payment accordingly.

The informing module 208 is configured for informing a corresponding undertaker of the updated information. In detail, the informing module 208 informs the undertaker in charge of the patent application, for example, by E-mails, in order to make the undertaker aware of the updated information.

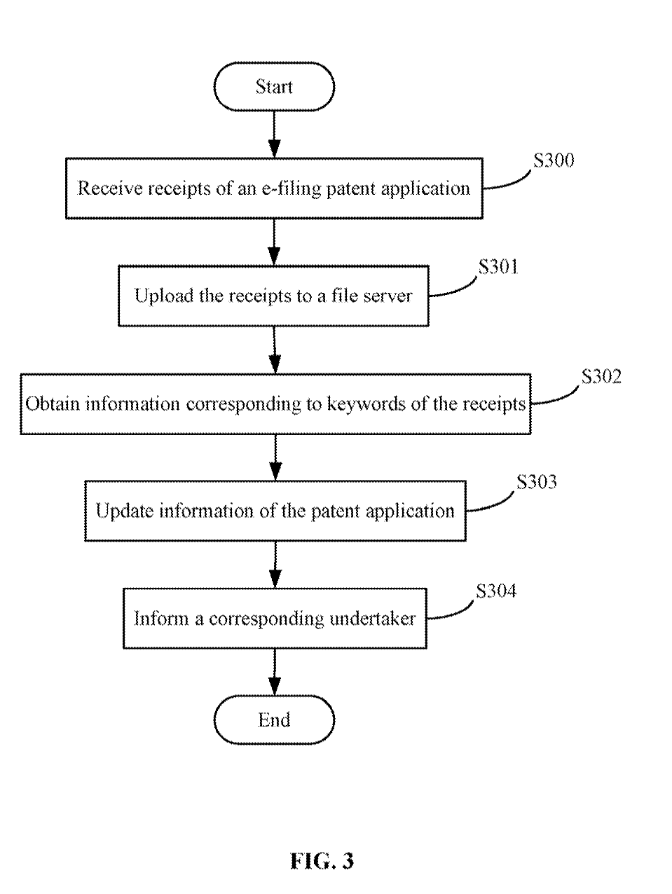

FIG. 3 is a flow chart illustrating a method for managing receipts of an e-filing patent application.

In step S300, the receiving module 200 receives one or more receipts from one of the patent office websites 130 via the Internet 106. The receipts, which can be XML files, PDF files or HTML files, are returned from the patent office website 130 when a patent application is filed electronically.

In step S301, the uploading module 202 uploads the one or more receipts to the file server 101 via the intranet 104.

In step S302, the processing module 204 obtains information corresponding to keywords of the one or more receipts. In detail, the processing module 204 reads the receipts and obtains information corresponding to keywords of the receipts. The keywords may include one or more of an application number, a filing date, a title of the invention, and fees payment.

In step S303, the updating module 206 updates information of the patent application in the database server 102 according to the information corresponding to the keywords. The information of the patent application at least includes an application number, a filing date, a title of the invention, and fees payment accordingly.

In step S304, the informing module 208 informs a corresponding undertaker of the updated information. In detail, the informing module 208 informs the undertaker in charge of the patent application, for example, by E-mails, in order to make the undertaker aware of the updated information.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for managing receipts of an e-filing patent application, the system comprising a file server, a database server connected to the file server and at least one client computer coupled to patent office websites through the Internet, the at least one client computer comprising:
a receiving module configured for receiving one or more receipts from one of the patent office websites via the Internet when a patent application is filed in the patent office electronically;
an uploading module configured for uploading the one or more receipts to the file server;
a processing module configured for obtaining information corresponding to keywords of the one or more receipts; and
an updating module configured for updating information of the patent application in the database server according to the information corresponding to the keywords.

2. The system according to claim 1, further comprising an informing module configured for informing a corresponding undertaker in charge of the patent application of the updated information.

3. The system according to claim 1, wherein the keywords of each receipt comprise an application number, a filing date, a title of the invention, and fees payment.

4. The system according to claim 3, wherein the information of the patent application comprises an application number, a filing date, a title of the invention, and fees payment.

5. A computer-based method for managing receipts of an e-filing patent application, the method comprising:
receiving one or more receipts from a patent office website via the Internet when a patent application is filed in the patent office electronically;
uploading the one or more receipts to a file server;
obtaining information corresponding to keywords of the one or more receipts; and
updating information of the patent application in a database server connected to the file server according to the information corresponding to the keywords.

6. The method according to claim 5, further comprising: informing a corresponding undertaker in charge of the patent application of the updated information.

7. The method according to claim 5, wherein the keywords of each receipt comprises an application number, a filing date, a title of the invention, and fees payment.

8. The method according to claim 7, wherein the information of the patent application comprises an application number, a filing date, a title of the invention, and fees payment.
